(19) United States
(12) Patent Application Publication
(10) Pub. No.: US 2012/0048109 A1
(43) Pub. Date: Mar. 1, 2012

(54) Mixed Matrix Membranes

(75) Inventors: Daniel Chinn, Bay Point, CA (US); De Q. Vu, El Cerrito, CA (US); Stephen J. Miller, San Francisco, CA (US); Paul F. Bryan, Pinole, CA (US); Curtis L. Munson, Alameda, CA (US)

(73) Assignee: CHEVRON U. S. A. INC., San Ramon, CA (US)

(21) Appl. No.: 12/862,215

(22) Filed: Aug. 24, 2010

(51) Int. Cl. B01D 53/14; B01J 20/28

(52) U.S. Cl. 95/130; 502/4

(57) ABSTRACT

Disclosed herein are mixed matrix membranes which include a continuous phase organic polymer with molecular sieves interspersed therein, the molecular sieves comprising one or more zeolites having an HEU structure type; wherein the membrane exhibits a mixed matrix effect and further wherein the membrane has a N₂/CH₄ selectivity of greater than about 5, at 35° C. and a pressure of 100 psia (690 kPa). Methods for their preparation and use are also disclosed.

### BACKGROUND

1. Technical Field

The present invention generally relates to mixed matrix membranes, methods for making the same, and their use in separating components of a gaseous mixture.

2. Description of the Related Art

The use of a gas separation membrane for separating a particular component from a mixture of gases is well known. See, e.g., U.S. Pat. Nos. 4,512,893, 4,717,394, 4,818,452, 4,902,422, 4,981,497, 5,042,993, 5,067,970, 5,165,963, 5,178,940, 5,234,471, 5,248,319, 5,262,056, 5,633,039 and 5,591,250. Examples of the type of gases separated by a gas separation membrane include carbon dioxide from methane, hydrogen from various gas mixtures, organic vapors from various gas mixtures, producing nitrogen, producing oxygen enriched air, etc. When using a gas separation membrane to separate a particular component from a gas mixture, one side of the membrane will be contacted with a multicomponent gas mixture. Typically, certain gas(es) in the gas mixture will permeate through the gas separation membrane at a faster rate than the other gas(es). The gas permeation rate through the gas separation membrane is a property of the membrane material composition and its morphology.

Gas separation membranes may be asymmetric, i.e., possessing a relatively dense, nonporous region and a relatively less dense, porous region, or they may be symmetric, i.e., possessing a substantially uniform, nonporous structure throughout. Examples of an asymmetric gas separation membrane can be found in U.S. Pat. Nos. 4,512,893, 4,818,452, 4,902,422, 5,067,970, 5,165,963, 5,178,940 and 5,633,039. This type of gas separation membrane can be obtained by a solvent evaporation/coagulation procedure.

Mixed matrix membranes have proven to be effective in separating gas components contained within a gaseous mixture. Mixed matrix membranes typically contain molecular sieves which are embedded within polymeric organic materials. Mixed matrix membranes exhibit the unusual property of higher selectivity of the combined molecular sieves and organic polymer than that of the organic polymer alone.

One example of such a mixed matrix membrane is disclosed in U.S. Pat. No. 5,127,925. Another exemplary patent is U.S. Pat. No. 4,925,459 which describes the use of molecular sieves supported by an organic polymer to create a membrane which is useful for the separation of gas components. In both patents, the membranes utilize zeolites as a molecular sieve. Zeolites are silica containing molecular sieves that have a particularly highly ordered crystalline structure often with desirable pore sizes and shapes conducive for fluid separations.

A zeolite support is a molecular sieve that contains silica in the tetrahedral framework positions. Examples include, but are not limited to, silica-only (silicates), silica-alumina (aluminosilicates), silica-boron (borosilicates), silica-germanium (germanosilicates), alumina-germanium, silica-gallium (gallosilicates) and silica-titania (titanosilicates), and mixtures thereof.

Molecular sieves, in turn, are crystalline materials that have regular passages (pores). If examined over several unit cells of the structure, the pores will form an axis based on the same units in the repeating crystalline structure. While the overall path of the pore will be aligned with the pore axis, within a unit cell, the pore may diverge from the axis, and it may expand in size (to form cages) or narrow. The axis of the pore is frequently parallel with one of the axes of the crystal. The narrowest position along a pore is the pore mouth. The pore size refers to the size of the pore mouth. The pore size is calculated by counting the number of tetrahedral positions that form the perimeter of the pore mouth. Molecular sieves may have pores of different structures or may have pores with the same structure but oriented in more than one axis related to the crystal. In these cases, the dimensionality of the molecular sieve is determined by summing the number of relevant pores with the same structure but different axes with the number of relevant pores of different shape. An example of the preparation of a zeolite, i.e., SSZ-13, is disclosed in U.S. Pat. No. 4,544,538. Still yet another example of the preparation of a zeolite, SSZ-62, is disclosed in U.S. Patent Application Publication No. 2003/0069449.

The manufacture of zeolites used in mixed matrix membranes may include the step of lowering the concentration of alkali metals in the zeolite by converting the zeolite to a hydrogen form. This is conventionally done by ion exchange, generally with ammonium cations. After ion-exchange, the zeolite is calcined to decompose the ammonium cations, thereby converting the zeolite from an ammonium form to the hydrogen form. While this method of treating zeolite particles prior to their incorporation into an organic polymer may benefit membrane selectivity and/or permeability to a degree, there is a need to discover improved zeolites and methods of treating those zeolites to achieve even better separation performance. While improved performance could also be achieved by increasing the zeolite content in a membrane, technical difficulties in membrane preparation (e.g., fiber spinning) and membrane strength can limit the amount of zeolite that can be added. Accordingly, finding a way to get more effective use from a given content of zeolite has distinct advantages. Higher selectivity provides less loss of retentate to a permeate stream of fluids being separated. Higher permeability also reduces the required membrane area, thereby reducing investment cost.

In converting zeolite to the hydrogen form, it has been found that if ammonium cations are not completely removed, the residual cations can partially restrict diffusion of a gas, e.g., CO₂, through pores in the zeolite, reducing membrane permeability and selectivity. Complete removal of the ammonium cations is difficult, requiring calcination at temperatures above 400° C., generally above 450° C. or even 500° C. This high temperature calcination can degrade certain properties of zeolites. While not wishing to be bound by theory, this could potentially result in dehydroxylation of silanol groups at the surface of the zeolite, where these groups are necessary for a high degree of attachment of silating agents. These silating agents can provide a bonding link between the zeolite and the membrane polymer phase. Without this link, gas may bypass the zeolite particles, diminishing separation selectivity. Other linking methods via surface silanol groups are also possible, such as through reactive groups in the polymer itself. Again, a decrease of these silanol groups negatively impacts that linking.

Another factor which can decrease zeolite effectiveness is residual amorphous siliceous material at the surface of the zeolite which can block surface sites and/or diminish diffusion of gases through the zeolite. Calcining the zeolite to remove the organic template prior to implementing procedures designed to remove amorphous material can anchor the amorphous material at the zeolite surface, making it difficult to remove and leading to poorer membrane performance. Blocking of surface sites can also lead to a diminishing of the surface charge (zeta-potential) of the zeolite, making the zeolite particles easier to agglomerate during membrane formation which can also lead to poorer membrane performance.

Gas separation through a glassy membrane mainly depends on the difference in diffusion coefficient for the two gas components, which is usually related to the difference in their kinetic diameter (size). CO₂ has a kinetic diameter of about 3.3 Angstroms, with CH₄ at about 3.8 Angstroms. However, the kinetic diameter of N₂ is about 3.6 Angstroms. Therefore, the difference between the kinetic diameter for N₂ versus methane is relatively small, such that getting a significant separation of these two gases using membranes has proven to be quite difficult. For nitrogen/methane, it is widely recognized that most membrane materials do not have the required separation characteristics.

Accordingly, there is a need to produce improved mixed matrix membranes with higher permeability and selectivity for nitrogen over methane. The present invention addresses this need by overcoming some of the above described shortcomings of conventional mixed matrix membranes and their manufacture.

### SUMMARY

In accordance with one embodiment, there is provided a mixed matrix membrane comprising: a continuous phase organic polymer with molecular sieves interspersed therein, the molecular sieves comprising one or more zeolites having an HEU structure type; wherein the membrane exhibits a mixed matrix effect and further wherein the membrane has a N₂/CH₄ selectivity of greater than about 5, at 35° C. and a pressure of 100 psia (690 kPa).

In accordance with another embodiment, there is provided a mixed matrix membrane comprising: a continuous phase organic polymer with molecular sieves interspersed therein, the molecular sieves comprising one or more zeolites having an HEU structure type and containing at least one exchanged metal cation; wherein the membrane exhibits a mixed matrix effect and further wherein the membrane has a N₂/CH₄ selectivity of greater than about 5, at 35° C. and a pressure of 100 psia (690 kPa).

In accordance with yet another embodiment, there is provided a method of making a mixed matrix membrane which comprises (a) providing a continuous phase organic polymer; (b) providing molecular sieves comprising one or more zeolites having an HEU structure type; (c) dispersing the molecular sieves into a solution containing the continuous phase organic polymer; and (d) allowing the continuous phase organic polymer to solidify about the molecular sieves to produce a mixed matrix membrane; whereby the mixed matrix membrane exhibits a mixed matrix effect and further wherein the membrane has a N₂/CH₄ selectivity of greater than about 5, at 35° C. and a pressure of 100 psia (690 kPa).

In accordance with yet another embodiment, there is provided a method for separating gas components from a feedstream containing a mixture of gas components, the method comprising:

(a) providing a mixed matrix membrane comprising: a continuous phase organic polymer with molecular sieves interspersed therein, the molecular sieves comprising one or more zeolites having a HEU structure type; and

(b) directing a feedstream including nitrogen and methane gas components to the feed side of the membrane and withdrawing a retentate stream depleted in the nitrogen gas component from the feed side and withdrawing a permeate stream enriched in the nitrogen gas component from the permeate side of the membrane, wherein the membrane has a N₂/CH₄ selectivity of greater than about 5 at 35° C. and a pressure of 100 psia (690 kPa).

The mixed matrix membranes disclosed herein are believed to advantageously possess improved selectivity for nitrogen over methane by use of molecular sieves comprising one or more zeolites having an HEU structure type interspersed in a continuous phase organic polymer. While many polymer membranes in the prior art provide relatively good separation of CO₂ and CH₄, there are fewer options to having a membrane having good separation of N₂ and CH₄ due to the difficulty of their separation.

### BRIEF DESCRIPTION OF THE DRAWINGS

FIG. 1 shows the Monoesterification and Transesterification Reactions.

FIG. 2 shows a plot of N₂/CH₄ selectivity vs. N₂ permeability.

### DETAILED DESCRIPTION OF THE EXEMPLARY EMBODIMENTS

The embodiments described herein are directed to mixed matrix membranes including a continuous phase organic polymer with molecular sieves interspersed therein, the molecular sieves comprising one or more zeolites having an HEU structure type; wherein the membrane exhibits a mixed matrix effect and further wherein the membrane has a N₂/CH₄ selectivity of greater than about 5, at 35° C. and a pressure of 100 psia (690 kPa). In one embodiment, the membrane has a N₂/CH₄ selectivity of greater than about 7, at 35° C. and a pressure of 100 psia (690 kPa). In another embodiment, the membrane has a N₂/CH₄ selectivity of greater than about 9, at 35° C. and a pressure of 100 psia (690 kPa).

Continuous phase polymers which can support the molecular sieves comprising one or more zeolites having an HEU structure type will first be described. Then, exemplary molecular sieves comprising one or more zeolites having an HEU structure type and optionally containing at least one exchanged metal cation to be incorporated into the continuous phase polymer will be taught. The molecular sieving entities increase the effective permeability of a desirable gas component through the polymeric membrane (and/or decrease the effective permeability of the other gas components), and thereby enhance the gas separation (selectivity) of the polymeric membrane material. Hereinafter, “enhanced” permeation properties or “enhanced” selectivity refers to this phenomenon. A method of making mixed matrix membranes utilizing the polymers and molecular sieves will next be described.

### I. Polymer Selection

An appropriately selected polymer can be used which permits passage of the desired gases to be separated, i.e., nitrogen and methane. In one embodiment, the polymer permits one or more of the desired gases to permeate through the polymer at different rates than other components, such that one of the individual gases, nitrogen, permeates at a faster rate than another gas, methane, through the polymer.

For use in making mixed matrix membranes for separating nitrogen and methane, suitable polymers include, by way of example, Ultem® 1000, Matrimid® 5218, 6FDA/BPDA-DAM, 6FDA-6FpDA, and 6FDA-IPDA (all polyimides). 6FDA/BPDA-DAM and 6FDA-IPDA are available from E.I. du Pont de Nemours and Company of Wilmington, Del. and are described in U.S. Pat. No. 5,234,471. Matrimid® 5218 is commercially available from Advanced Materials of Brewster, N.Y. Ultem® 1000 may be obtained commercially from General Electric Plastics of Mount Vernon, Ind.

In another embodiment, examples of suitable polymers include substituted or =substituted polymers and may be selected from polysulfones; poly(styrenes), including styrene-containing copolymers such as acrylonitrilestyrene copolymers, styrene-butadiene copolymers and styrene-vinylbenzylhalide copolymers; polycarbonates; cellulosic polymers, such as cellulose acetate-butyrate, cellulose propionate; ethyl cellulose, methyl cellulose, nitrocellulose, etc.; polyamides and polyimides, including aryl polyamides and aryl polyimides; polyethers; polyetherimides; polyetherketones; poly(arylene oxides) such as poly(phenylene oxide) and poly(xylene oxide); poly(esteramide-diisocyanate); polyurethanes; polyesters (including polyarylates), such as polyethylene terephthalate), poly(alkyl methacrylates), poly(acrylates), poly(phenylene terephthalate), etc.; polypyrrolones; polysulfides; polymers from monomers having alpha-olefinic unsaturation other than mentioned above such as poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly (benzimidazole); polycarbodiimides; polyphosphazines; etc., and interpolymers, including block interpolymers containing repeating units from the above such as terpolymers of acrylonitrile-vinyl bromide-sodium salt of para-sulfophenylmethallyl ethers; and grafts, copolymers and blends containing any of the foregoing. Typical substituents providing substituted polymers include halogens such as fluorine, chlorine and bromine; hydroxyl groups; lower alkyl groups; lower alkoxy groups; monocyclic aryl; lower acyl groups and the like.

Preferably, the polymer is a glassy polymer as opposed to a rubbery polymer. Glassy polymers which are flexible are preferred for a hollow fiber. Glassy polymers are differentiated from rubbery polymers by the rate of segmental movement of polymer chains. Polymers in the glassy state do not have the rapid molecular motions that permit rubbery polymers their liquid-like nature and their ability to adjust segmental configurations rapidly over large distances (>0.5 nm). Glassy polymers exist in a non-equilibrium state with entangled molecular chains with immobile molecular backbones in frozen conformations. The glass transition temperature (T_{g}) is the dividing point between the rubbery or glassy state. Above the T_{g}, the polymer exists in the rubbery state; below the Tₛ, the polymer exists in the glassy state. Generally, glassy polymers provide a selective environment for gas diffusion and are favored for gas separation applications. Glassy polymers describe polymers with polymer chain backbones that have limited intramolecular rotational mobility and are often characterized by having high glass transition temperatures (T_{g}>150° C.).

In glassy polymers, the diffusion coefficient tends to dominate, and glassy membranes tend to be selective in favor of small, low-boiling molecules. Suitable gas separation membranes can be made from glassy polymer materials that will pass nitrogen preferentially over methane and other light hydrocarbons. Such polymers are well known in the art and are described, for example, in U.S. Pat. Nos. 4,230,463 and 3,567,632. Suitable membrane materials include polyimides, polysulfones and cellulosic polymers.

The polyimide is derived from a reaction of any suitable reactants. Reactants can include monomers such as dianhydrides, as well as tetra carboxylic acids, and furandiones. Other monomers include diamino compounds, preferably diamino cyclic compounds, still more preferably diamino aromatics. The diamino aromatics can include aromatic compounds having more than one aromatic ring where the amino groups are on the same or different aromatic ring.

In one embodiment, the continuous phase polymer is a crosslinked polymer. Accordingly, in this embodiment, it is also important for the polymer such as a polyimide to have incorporated in it a predetermined amount of crosslinkable sites. A crosslinked continuous phase polymer can be obtained by processes known in the art, e.g., as described in U.S. Pat. No. 6,755,900, the contents of which are incorporated by reference herein. These sites may include, but are not limited to, carboxylic acid sites, ester functions, —OH groups, unreacted NH₂ groups, —SH groups, amide functions, olefins and the like and combinations thereof. In one embodiment, crosslinkable sites are carboxylic acid or ester groups, alcohols, and olefins.

Crosslinking can also be induced by reaction of the imide function itself to form a crosslinkable site and an amide. The process of crosslinking will be discussed in more detail later. One feature of this process is that the polyimide chains have limited rotational ability. One such monomer that provides a polyimide chain with limited rotational ability is a dianhydride, also known as 6FDA or 4,4′-(hexafluoroisopropylidene) diphthalic anhydride, or (2,2-bis(3,4-dicarboxyphenyl)hexafluoropropane dianhydride. In one process for preparing crosslinked polymer, a carboxylic acid functionality is intended to include the acid group itself as well as acid derivatives such as esters and anhydrides as well as activated carboxylic acid derivatives such as acid chlorides.

One exemplary monomer for providing the carboxylic acid functionality is diamino benzoic acid; another is 3,5 diaminobenzoic acid.

The diamino cyclic compounds without a carboxylic acid functionality can include aromatic compounds having more than one aromatic ring where the amino groups are on the same or different aromatic ring. Representative examples include, but are not limited to, 4,4′ isopropyl idene dianiline, 3,3′ hexafluoroisopropylidene dianiline, 4,4′ hexafluoroisopropylidene dianiline, 4,4′ oxydianiline, 3,3′ oxydianiline and 4,4′ diaminodiphenyl. Representative examples of diamino aromatic compounds include diaminotoluene, diaminobenzotrifluoride, and di, tri, and tetramethyldiaminobenzene.

In the case of crosslinkable sites comprising carboxylic acid or esters or activated carboxylic acid derivatives, suitable crosslinking groups or agents include diols such as ethylene glycol, propylene glycol, 1,3 propanediol, 1,4 butanediol, 1,2 butanediol, benzenedimethanol, 1,3 butanediol and the like. In one preferred embodiment, crosslinking agents include ethylene glycol, propylene glycol, 1,3 propanediol, and benzenedimethanol. It has been found that having a crosslinking group that is too long can have an undesirable impact on the permeability and/or selectivity of the polymer whereas having a crosslinking group that is too short can also have a negative impact on the finished hollow fiber membrane. The most preferred crosslinking agent for crosslinking carboxylic acid or ester sites is 1,3 propanediol.

Crosslinking can occur by the condensation reaction of selected diol or diols with the crosslinkable acid functionality. In one embodiment, the reaction of less reactive crosslinking agents can be facilitated by activation of the carboxylic acid site on the polymer chain. One way to accomplish this is by converting the acid group to the corresponding acid chloride. This can be effectively done by the use of thionyl chloride.

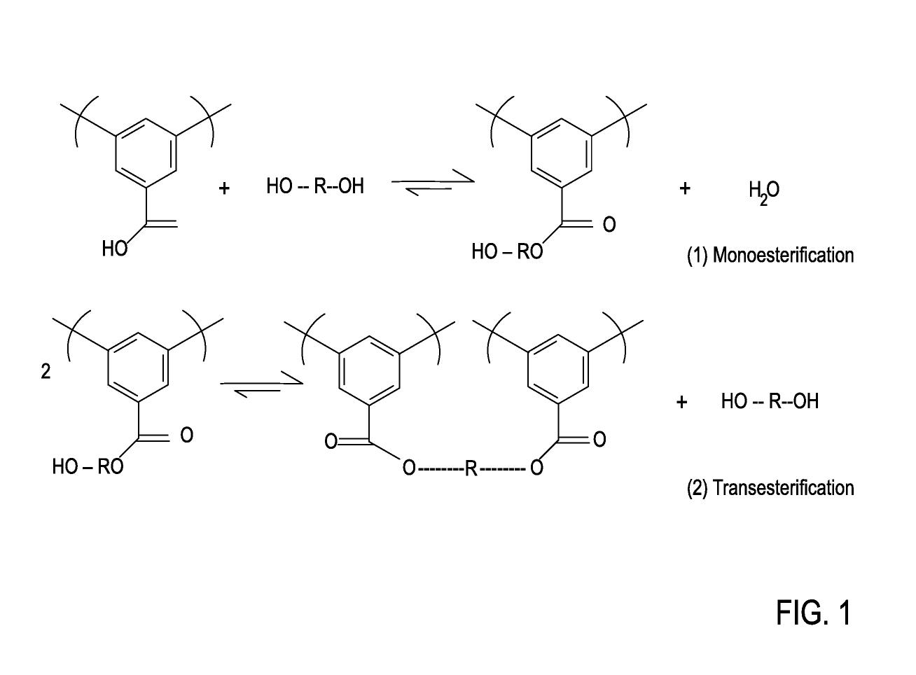

In one embodiment, crosslinking can be achieved in a stepwise fashion by first monoesterification of the acid function with the selected diol or diols, followed by transesterification of the monoester to the diester. (See FIG. 1)

In another embodiment, the monoesterified polymer is spun into the hollow fiber prior to transesterification to form the crosslinked hollow fiber membrane. There are significant advantages to this process in particular the monoester polymer can be more easily spun without breaking or forming defects.

Alcohol or —OH groups can also provide crosslinkable sites. Crosslinking groups useable with alcohol crosslinkable sites include dicarboxylic acids, anhydrides, and diesters. Representative examples of dicarboxylic acids useful as crosslink groups include, but are not limited to, oxalic acid, malonic acid, succinic acid, methylsuccinic acid, glutaric acid, adipic acid and the like and mixtures thereof. Representative examples of anhydrides that may be used include, but are not limited to, maleic anhydride, succinic anhydride, methylsuccinic anhydride and the like and mixtures thereof. Representative examples of diesters include, but are not limited to, dimethylterephthalate, dimethylisophthalate, dimethylphthalate, diesters of the dicarboxylic acids mentioned above and the like and mixtures thereof. The dicarboxylic acids and anhydrides can be reacted with the —OH containing polyimide at esterification to form a crosslink. Likewise the diesters discussed above can be subjected to transesterification conditions in the presence of the —OH containing polyimide to form the desired ester crosslink.

In one embodiment, the —OH containing polyimide is subjected to monoesterification conditions in the presence of one or more of the crosslinking groups to form a monoesterified polyimide, which can then be made into a hollow fiber. The hollow fiber can then be subjected to transesterification conditions after hollow fiber formation to form the crosslinked hollow fiber polymer membrane.

Representative examples of reactants that can be used to provide an —OH containing polyimide include diaminobenzyl alcohol, diaminocyclohexanol, and other diaminoalcohols.

In some cases, it may be advantageous to protect the —OH function prior to formation of the polyimide. This can be done by conventional chemical means such as by masking the —OH group off as an ether. The masked —OH group can then be hydrolyzed back to a functional —OH group prior to crosslinking or prior to the extrusion of the hollow fiber.

Crosslinking groups useable with olefins include, but are not limited to, sulfur, divinylbenzene and the like. Sulfur as a crosslinking agent is believed to form a disulfide crosslink when reacted with an olefin.

A preferred diamino group that can be used to make a crosslinkable polyimide polymer is diaminobenzoic acid (DABA). A preferred isomer of DABA is 3,5 diaminobenzoic acid.

In an alternative embodiment, a crosslinking-like effect can be achieved simply by the presence of crosslinkable groups in the polymer chain. Crosslinkable groups such as carboxylic acid functions can have an effect very similar to actual covalent crosslinking. This effect can be referred to as pseudocrosslinking. Not to be limited by theory, pseudocrosslinking is thought to occur because the crosslinkable groups can provide a weak attractive interaction between polymer chains that behaves similarly to actual crosslinking. The interaction can be a weak ionic bond, hydrogen bond or Van der Waals forces. These weak interactions cause the polymer to be weakly crosslinked.

In another alternative embodiment, only a fraction of the available crosslinkable sites are actually crosslinked. In this embodiment, the resultant polymer membrane has a combination of true crosslinks and pseudocrosslinks. Such a combination can have processing and durability advantages.

In yet another embodiment, the crosslinkable sites are selected such that some of said sites interact with the molecular sieve material such that a weak bond is formed between the polymer and the sieve via the crosslinkable sites. In this way the crosslinkable site serves at least two roles. It provides a site to facilitate crosslinking of the polymer chains and it aids in making the polymer more compatible with the molecular sieve. Thus the crosslinkable group acts as a self primer.

In another embodiment, thermally crosslinked polymers can be used herein, such as those disclosed in U.S. Patent Application Publication No. 20080061838. Examples of such thermally crosslinked polymers include 6FDA:DAM:DABA polymers, but without crosslinkers, such as diols. Also, no monoesterification step is necessary to provide such polymers.

### II. Molecular Sieve Selection

The molecular sieve that can be used in making the mixed matrix membranes described herein include one or more zeolites having an HEU structure type. The HEU zeolite structure type is assigned by the IZA Structure Commission following the rules set up by the IUPAC Commission on Zeolite Nomenclature. Each unique framework topology is designated by a structure type code consisting of 3 capital letters, i.e., HEU structure type. Molecular sieves comprising one or more zeolites having an HEU structure type are believed to improve the performance of the mixed matrix membrane by including selective holes/pores with a size that permits a nitrogen gas to pass through, but either not permitting methane gas to pass through, or permitting it to pass through at a significantly slower rate. Zeolites having a HEU structure type include clinoptilolite and huelandite and the like and mixtures thereof. HEU framework information is given in Atlas of Zeolite Framework Types, 6^{th} Revised Edition, Baerlocher, McCusker, and Olson, eds., Elsevier, 2007, the contents of which are incorporated by reference herein. In one embodiment, the zeolite is clinoptilolite. The molecular sieves useful in the embodiments described herein are 3-dimensional. It is believed that this multi-dimensional character will allow for better diffusion through the sieves and the membrane.

Cation modification of the zeolites can be used to affect the separation characteristics of the zeolite. Such cation modification includes ion exchange where metal ions in the zeolite such as sodium or potassium are replaced with other metal ions or any other selected exchangeable ion. In one embodiment, suitable metal cations to be exchanged with metal ions in the zeolite include Groups IA and IIA metals of the Periodic Table. In the event that cation modification is carried out, one skilled in the art will readily appreciate that when the zeolite contains a metal ion such as sodium or potassium, it is advantageous to exchange those ions with a different metal cation, i.e., a metal cation of Group IA which is not sodium or potassium or those of Group IIA. In one embodiment, suitable metal cations to be exchanged with metal ions in the zeolite include Group IIA metals of the Periodic Table. Suitable Group IA metals include, but are not limited to, lithium, sodium, potassium, rubidium, cesium, and francium. Suitable Group IIA metals include, but are not limited to, beryllium, magnesium, calcium, strontium, barium and radium. In one embodiment, the metal ions in the zeolite are replaced with ions of magnesium. This can be done to adjust the adsorption characteristics of the zeolite thus increasing the selectivity. In one embodiment, the amount of metal cation exchanged with the metal ions in the zeolite can range from about 25 to about 100 wt. %, as determined by inductively-coupled plasma (ICP) chemical analysis technique. In another embodiment, the amount of metal cation exchanged with the metal ions in the zeolite can range from about 50 to about 100 wt. %, as determined by ICP.

The average particle size of the molecular sieve useful in the embodiments described herein is less than about 10 microns. In another embodiment, the average particle size of the molecular sieve is less than about 2 microns. In another embodiment, the average particle size of the molecular sieve is less than about 1 microns.

A variety of analytical methods are available to practitioners for determining the size of small particles. For example, one such method employs a Coulter Counter, which uses a current generated by platinum electrodes on two sides of an aperture to count the number, and determine the size, of individual particles passing through the aperture. The Coulter Counter is described in more detail in J. K. Beddow, ed., Particle Characterization in Technology, Vol. 1, Applications and Microanalysis, CRC Press, Inc, 1984, pp. 183-6, and in T. Allen, Particle Size Measurement, London: Chapman and Hall, 1981, pp. 392-413. A sonic sifter, which separates particles according to size by a combination of a vertical oscillating column of air and a repetitive mechanical pulse on a sieve stack, can also be used to determine the particle size distribution of particles used in the process of this invention. Sonic sifters are described in, for example, T. Allen, Particle Size Measurement, London: Chapman and Hall, 1981, pp. 175-176. The average particle size may also be determined by a laser light scattering method, using, for example, a Malvern MasterSizer instrument. An average particle size may then be computed in various well-known ways, including

$$Number Average = \frac{{\sum }_{i = 1}^{n} ( {z}_{i} \times {L}_{i} )}{{\sum }_{i = 1}^{n} {z}_{i}}$$

wherein zᵢ is the number of particles whose length falls within an interval L₁. For purposes of this invention, average crystal size will be defined as a number average.

The zeolite particle size can be reduced after synthesis such as by high shear wet milling. Prior to membrane formation, the zeolite may be silanated, either during wet milling or separately. Suitable metal cations include any alkali or alkaline earth metal.

Techniques for the ion-exchange of zeolite having an HEU structure type such as clinoptilolite are well-known to those skilled in the molecular sieve art. For example, ion exchange techniques involve contacting the zeolite with a solution containing a salt of the desired replacing cation or cations. Although a wide variety of salts can be employed, chlorides and other halides, nitrates, and sulfates are preferred. Representative ion exchange techniques are disclosed in a wide variety of patents including U.S. Pat. Nos. 3,140,249; 3,140,251; and 3,140,253. Ion exchange can take place either before or after the zeolite is calcined. Following contact with the salt solution of the desired replacing cation, the zeolite is typically washed with water and dried at temperatures ranging from 65° C. to about 315° C.

After washing, the zeolite can be calcined in air or inert gas at temperatures ranging from about 200° C. to 820° C. for periods of time ranging from 1 to 48 hours, or more, to produce a catalytically active product especially useful in hydrocarbon conversion processes. Regardless of the cations present in the synthesized form of the zeolite, the spatial arrangement of the atoms which form the basic crystal lattice of the zeolite remains essentially unchanged. The exchange of cations has little, if any, effect on the zeolite lattice structures.

It is desirable that the ion-exchange be continued until at least about 50 percent, and preferably at least about 70 percent, of the cations in the original clinoptilolite have been replaced, and in most cases it is convenient to continue the ion-exchange until no further amount of the desired cation can easily be introduced into the clinoptilolite. To secure maximum replacement of the original clinoptilolite cations, it is recommended that the ion-exchange be conducted using a solution containing a quantity of the cation to be introduced which is from about 2 to about 100 times the ion-exchange capacity of the clinoptilolite. Generally, the ion-exchange solution will be contacted with the original clinoptilolite for at least about 1 hour. The ion-exchange may be conducted at ambient temperature, although in many cases carrying out the ion-exchange at elevated temperatures, usually less than 90° C., accelerates the ion-exchange process.

By carrying out the metal cation exchange in the zeolite with one or more Group IA or IIA metals, the pore size of the molecular sieve is believed to be effected thereby resulting in improved N₂/CH₄ selectivity.

For the intended use, it is advantageous to obtain fluid separation membranes having pore size and a pore size distribution that effectively separate specific mixtures of nitrogen and methane.

In one embodiment, the molecular sieves contain ultramicropores of an effective size and geometry such that when the molecular sieves are dispersed in the continuous phase polymer and a mixed matrix membrane is prepared having about 20% by weight loading of sieves, the membrane exhibits a pure gas selectivity enhancement of 10% or more in permeability of N₂ relative to CH₄ when compared against a membrane made of the same continuous phase polymer but without the molecular sieves.

In another embodiment, the molecular sieves contain ultramicropores of an effective size and geometry such that when the molecular sieves are dispersed in the continuous phase polymer and a mixed matrix membrane is prepared having about 30% by weight loading of sieves, the membrane exhibits a pure gas selectivity enhancement of 20% or more in permeability of N₂ relative to CH₄ when compared against a membrane made of the same continuous phase polymer but without the molecular sieves.

In another embodiment, the molecular sieves contain ultramicropores of an effective size and geometry such that when the molecular sieves are dispersed in the continuous phase polymer and a mixed matrix membrane is prepared having about 40% by weight loading of sieves, the membrane exhibits a pure gas selectivity enhancement of 30% or more in permeability of N₂ relative to CH₄ when compared against a membrane made of the same continuous phase polymer but without the molecular sieves.

### III. Methods of Forming Mixed Matrix Membrane

The molecular sieves can optionally be “primed” (or “sized”) by adding a small amount of the desired matrix polymer or any suitable “sizing agent” that will be miscible with the organic polymer to be used for the matrix phase. Generally, this small amount of polymer or “sizing agent” is added after the molecular sieves have been dispersed in a suitable solvent and sonicated by an ultrasonic agitator source. Optionally, a non-polar non-solvent, in which the polymer or “sizing agent” is insoluble, may be added to the dilute suspension to initiate precipitation of the polymer onto the molecular sieves. The “primed” molecular sieves may be removed through filtration and dried by any conventional means, for example in a vacuum oven, prior to re-dispersion in the suitable solvent for casting. The small amount of polymer or “sizing agent” provides an initial thin coating (i.e., boundary layer) on the molecular sieve surface that will aid in making the particles compatible with the polymer matrix.

In one embodiment, approximately 10% of total polymer material amount to be added for the final mixed matrix membrane is used to “prime” the molecular sieves. The slurry is agitated and mixed for preferably between about 0.5 to about 8 hours. After mixing, the remaining amount of polymer to be added is deposited into the slurry. The quantity of molecular sieves and the amount of polymer added will determine the “loading” (or solid particle concentration) in the final mixed matrix membrane. The loading of molecular sieves can range, as a non-limiting example, from about 10 vol. % to about 60 vol. %. In one embodiment, the loading of molecular sieves can range from about 20 vol. % to about 50 vol. %. To achieve a desirable viscosity, the polymer solution concentration in the solvent can range, for example, from about 5 wt. % to about 25 wt. %. Finally, the slurry is again well agitated and mixed by any suitable means for about 0.5 to about 8 hours.

This technique of “priming” the particles with a small amount of the polymer before incorporating the zeolite particles into a polymer film is believed to make the particles more compatible with the polymer. It is also believed to promote greater affinity and adhesion between the particles and the polymers and may eliminate defects in the mixed matrix membranes.

In the case of forming a film, the mixed matrix membranes are typically formed by casting the homogeneous slurry containing zeolite particles and the desired polymer, as described above. The slurry can be mixed, for example, using homogenizers and/or ultrasound to maximize the dispersion of the particles in the polymer or polymer solution. In one embodiment, the casting process is performed by the steps: (1) pouring the solution onto a flat, horizontal surface (preferably a glass surface); (2) slowly and virtually completely evaporating the solvent from the solution to form a solid membrane film; and (3) drying the membrane film.

To control the membrane thickness and area, the solution can be poured into a metal ring mold. Slow evaporation of the solvent can be effected by covering the area and restricting the flux of the evaporating solvent. Generally, evaporation can take up to about 12 hours to complete, but can take longer depending on the solvent used. The solid membrane film can be removed from the flat surface and placed in a vacuum oven to dry. The temperature of the vacuum oven can be from about 50° C. to about 110° C. (or about 50° C. above the normal boiling point of the solvent) to remove remaining solvent and to anneal the final mixed matrix membrane.

In the case of forming a fiber, the mixed matrix membranes are typically formed by incorporating the polymer and molecular sieve into a spinning dope, which is spun into hollow fiber by means of a spinning process such as a wet-quench/dry-jet spinning process. While a wet-quench/dry-jet spinning process is discussed in detail below, it should be appreciated that other types of spinning methods (e.g. wet spinning) can be used to form the hollow fiber. An example of a useful spinning process is disclosed in U.S. Patent Application Publication No. 20090178561, the contents of which are incorporated by reference herein.

The final, dried mixed matrix membrane can be further annealed above its glass transition temperature (T_{g}). The T_{g} of the mixed matrix membrane can be determined by any suitable method (e.g., differential scanning calorimetry). The mixed matrix film can be secured on a flat surface and placed in a high temperature vacuum oven. The pressure in the vacuum oven can be between about 0.01 mm Hg to about 0.10 mm Hg. In one embodiment, the system is evacuated until the pressure is 0.05 mm Hg or lower. A heating protocol can be programmed so that the temperature reaches the T_{g} of the mixed matrix membrane preferably in about two to three hours. The temperature is then raised to preferably about 10° C. to about 30° C., but most preferably about 20° C., above the T_{g} and maintained at that temperature for about 30 minutes to about two hours. After the heating cycle is complete, the mixed matrix membrane is allowed to cool to ambient temperature under vacuum.

The membranes can be used in any convenient form such as sheets, tubes or hollow fibers. Hollow fibers provide a relatively large membrane area per unit volume. Sheets can be used to fabricate spiral wound modules familiar to those skilled in the art.

For flat-sheet membranes, the thickness of the mixed matrix selective layer is between about 0.001 and 0.005 inches (between about 0.025 and 0.13 mm). In one embodiment, the thickness of the mixed matrix selective layer is between about 0.002 inches (about 0.05 mm). In asymmetric hollow fiber form, the thickness of the mixed matrix selective skin layer is about 1000 Angstroms to about 5000 Angstroms. The loading of particles in the continuous polymer phase is between about 10% and 60%, by volume. In one embodiment, the loading of particles in the continuous polymer phase is between about 20% to 50% by volume.

The resulting mixed matrix membrane is an effective membrane material for separation of nitrogen from methane.

### IV. Mixed Matrix Membrane Enhancement Test For Membranes

A test can be prepared to verify that the molecular sieves have been properly and successfully made to produce mixed matrix membranes with greatly enhanced permeation properties. This test involves preparation of a sample mixed matrix membrane film using a test polymer and a specified loading of molecular sieves, and comparing the N₂/CH₄ permeation and selectivity versus a membrane film of the same test polymer without added molecular sieves. The N₂/CH₄ permeation selectivity is determined by taking the ratio of the permeability of N₂ over that of CH₄. The permeability of a gas penetrant i is a pressure- and thickness-normalized flux of the component through the membrane and is defined by the expression:

$${P}_{i} = \frac{{N}_{i} \cdot l}{Δ {p}_{i}}$$

where Pᵢ is permeability of component i, l is thickness of the membrane layer, Nᵢ is component i's flux (volumetric flow rate per unit membrane area) through the membrane, and Δpᵢ is the partial pressure driving force of component i (partial pressure difference between the upstream and the downstream). Permeability is often expressed in the customary unit of Barrer (1 Barrer=10⁻¹⁰ cm³ (STP)·cm/cm²·s·cm Hg). Permeability measurements can be made using a manometric, or constant volume, method. The apparatus for performing permeation measurements in films is described in O'Brien et al., J. Membrane Sci., 29, 229 (1986) and Costello et al., Ind. Eng. Chem. Res., 31, 2708 (1992), the contents of which are hereby incorporated by reference.

In the N₂/CH₄ Mixed Matrix Enhancement Test, also referred to herein as the Enhancement Test, permeation tests of pure gases of N₂ and CH₄ are performed on the mixed matrix membrane. The mixed matrix membrane film is separately tested with each gas using an upstream pressure of about 50 psig (345 kPa) and a vacuum downstream. A temperature of about 35° C. is maintained inside the permeation system. Similar permeation tests of pure gases of N₂ and C₄ are performed on a prepared membrane film of the same test polymer without added sieves. To confirm that the molecular sieves particles have been properly prepared by the methods described herein, the mixed matrix membrane film should exhibit a N₂/CH₄ selectivity enhancement in the N₂/CH₄ Mixed Matrix Enhancement Test of 10% or more, and preferably 15% or more, over the N₂/CH₄ selectivity of the pure test polymer membrane alone.

The method for forming the sample mixed matrix membrane for use in the Enhancement Test is as follows:

(1) The molecular sieve is first silanated according to the following procedure:
(a) A 200 mL of 95:5 (by volume) solution of isopropyl alcohol (ACS certified grade or better) and DI water is prepared.
(b) 4 grams of a silane coupling agent (3-aminopropyldimethylethoxysilane, APDMES is the standard) is added to the molecular sieve (5 grams, based on dry weight) in a plastic container. Next, add the IPA solution prepared in step (a).
(c) The mixture is sonicated with an ultrasonic horn for 30 minutes in five minute intervals (five minutes sonication followed by five minutes of resting).
(d) The solution is filtered with a high pressure (about 120 psi (830 kPa)) nitrogen filtration setup (Pall Gelman #4280) using 0.2 μm PTFE filter paper.
(e) Once filtration is complete, 100 mL fresh IPA is added and the mixture is sonicated above the paper, being careful not to contact the filter paper with the sonicator tip. This breaks up the cake so that excess APDMES is evenly washed off the surface. This procedure is repeated with two additional aliquots of IPA.
(f) Set the molecular sieve aside until ready to incorporate into a film.

(2) For the purpose of the Enhancement Test, the polymer to be used for the matrix phase is Ultem® 1000 (GE Plastics). Its chemical structure is shown below.

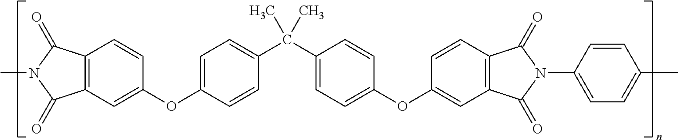

where n is the number of repeating units.

Prior to use, the Ultem® 1000 and silanated zeolite are dried under vacuum at a temperature of about 120° C. in a vacuum oven. For “priming” the particles, a 25 wt. % Ultem® 1000 solution in CHCl₃ is prepared and set aside until molecular sieve priming is complete. Next, 1.5 grams of the silanated molecular sieve and 0.2 grams Ultem® 1000 in 200 mL NMP(N-methylpyrolidone) are dispersed via sonication for two minutes in a round bottom flask. This mixture is maintained at 140° C. (oil bath) for four hours under a dry nitrogen purge, stirring constantly. The solution is filtered with 0.2 μm filter paper, the resulting cake is washed three times with pure NMP, and then dried overnight at 135° C. in a vacuum oven.

A portion of the molecular sieve is dispersed for two minutes via sonication in a sufficient amount of CHCl₃ so that the polymer-sieve-solvent system has 15% solids. A sufficient amount of the a 25 wt. % Ultem® 1000 solution in CHCl₃ is added to give a 15:85 sieve:polymer mixture, and the solution is allowed to gently mix on a roller until it appears homogeneous. The solution is removed from the roller ten minutes before casting to allow any entrapped bubbles to escape.

The solution is cast on Teflon® coated glass in a glove bag with a 10 mil casting knife with Al tape added to the bottom to increase the clearance to 16 mil and covered with a funnel to control evaporation rate. The film is removed carefully by pulling it off the surface, and dried in an aluminum foil envelope in the vacuum oven at 180° C. for seven days.

(3) To perform the Enhancement Test, permeability measurements of the flat mixed matrix membrane films are required. The measurements can be made using a manometric, or constant volume, method. A sample film area from final mixed matrix film is masked with adhesive aluminum masks having a circular, pre-cut, exposed area for permeation through the membrane. The masked membrane can be placed in a permeation cell in a permeation system. Both the upstream and downstream sections of the permeation system are evacuated for about 24 hours to 48 hours to remove (“degas”) any gases or vapors sorbed into the membrane. Permeation tests of the membrane can be performed by pressurizing the upstream side with the desired gas at the desired pressure, in this test 50 psig (345 kPa) with a temperature of 35° C. The permeation rate can be measured from the pressure rise of a pressure transducer and using the known downstream (permeate) volume. Following the permeation testing of a given gas, both the upstream and downstream sections are evacuated for at least 12 hours before permeation testing of the next gas.

With the above procedure, the N₂ and CH₄ permeabilities are measured for the test mixed matrix membrane and the pure test polymer (Ultem® 1000). The N₂/CH₄ selectivity of the mixed matrix membrane is compared to the N₂/CH₄ selectivity of the pure test polymer (Ultem® 1000) alone. A N₂/CH₄ selectivity enhancement of 10% or more should be observed in the mixed matrix membrane film.

### V. Separation Systems Including the Membranes

The membranes may take any form known in the art, for example hollow fibers, tubular shapes, and other membrane shapes. Some other membrane shapes include spiral wound, pleated, flat sheet, or polygonal tubes. Multiple hollow fiber membrane tubes may be desired for their relatively large fluid contact area. The contact area may be further increased by adding additional tubes or tube contours. Contact may also be increased by altering the gaseous flow by increasing fluid turbulence or swirling.

For flat-sheet membranes, the thickness of the mixed matrix selective layer is between about 0.001 and 0.005 inches (between about 0.025 and 0.13 mm), preferably about 0.002 inches (about 0.05 mm). In asymmetric hollow fiber form, the thickness of the mixed matrix selective skin layer can be about 1,000 Angstroms to about 5,000 Angstroms.

The glassy materials that provide good gas selectivity, for example, nitrogen/methane selectivity, tend to have relatively low permeabilities. In one embodiment, the form for the membranes is integrally skinned or composite asymmetric hollow fibers, which can provide both a very thin selective skin layer and a high packing density, to facilitate use of large membrane areas. Hollow tubes can also be used.

Sheets can be used to fabricate a flat stack permeator that includes a multitude of membrane layers alternately separated by feed-retentate spacers and permeate spacers. The layers can be glued along their edges to define separate feed-retentate zones and permeate zones. Devices of this type are described in U.S. Pat. No. 5,104,532, the contents of which are hereby incorporated by reference.

The membranes can be included in a separation system that includes an outer perforated shell surrounding one or more inner tubes that contain the mixed matrix membranes. The shell and the inner tubes can be surrounded with packing to isolate a contaminant collection zone.

In one mode of operation, a gaseous mixture enters the separation system via a containment collection zone through the perforations in the outer perforated shell. The gaseous mixture passes through the inner tubes. As the gaseous mixture passes through the inner tubes, one or more components of the mixture permeate out of the inner tubes through the selective membrane and enter the containment collection zone.

The membranes can be included in a cartridge and used for permeating contaminants from a gaseous mixture. The contaminants can permeate out through the membrane, while the desired components continue out of the membrane. The membranes may be stacked within a perforated tube to form the inner tubes or may be interconnected to form a self-supporting tube. Each of the stacked membrane elements may be designed to permeate one or more components of the gaseous mixture. For example, one membrane may be designed for removing nitrogen, a second for removing hydrogen sulfide, and a third for removing carbon dioxide. The membranes may be stacked in different arrangements to remove various components from the gaseous mixture in different orders.

Different components may be removed into a single contaminant collection zone and disposed of together, or they may be removed into different zones. The membranes may be arranged in series or parallel configurations or in combinations thereof depending on the particular application.

The membranes may be removable and replaceable by conventional retrieval technology such as wire line, coil tubing, or pumping. In addition to replacement, the membrane elements may be cleaned in place by pumping gas, liquid, detergent, or other material past the membrane to remove materials accumulated on the membrane surface.

A gas separation system including the membranes described herein may be of a variable length depending on the particular application. The gaseous mixture can flow through the membrane(s) following an inside-out flow path where the mixture flows into the inside of the tube(s) of the membranes and the components which are removed permeate out through the tube. Alternatively, the gaseous mixture can flow through the membrane following an outside-in flow path.

In order to prevent or reduce possibly damaging contact between liquid or particulate contaminates and the membranes, the flowing gaseous mixture may be caused to rotate or swirl within an outer tube. This rotation may be achieved in any known manner, for example, using one or more spiral deflectors. A vent may also be provided for removing and/or sampling components removed from the gaseous mixture.

### VI. Purification Process

A mixture containing the nitrogen and methane gases to be separated can be enriched by a gas-phase process through the mixed matrix membrane, for example, in any of the above-configurations. In one embodiment, the conditions for enriching the mixture involve using a temperature between about 25° C. and about 200° C. and a pressure of between about 50 psia (345 kPa) and about 5,000 psia (34.5 MPa). These conditions can be varied using routine experimentation depending on the feedstreams.

The gases that can be separated are those with kinetic diameters that allow passage through the molecular sieves. The kinetic diameter (also referred to herein as “molecular size”) of gas molecules are well known, and the kinetic diameters of voids in molecular sieves are also well known, and are described, for example, in D. W. Breck, Zeolite Molecular Sieves, Wiley (1974), the contents of which are hereby incorporated by reference.

The following non-limiting examples are illustrative of the present invention.

Mathematically, gas transport through a mixed matrix medium presents a complex problem. Several theoretical models have been used to predict the permeation properties of mixed matrix (or heterogeneous) membranes as functions of the permeabilities of the continuous and dispersed phases. J. H. Petropoulos, A comparative study of approaches applied to the permeability of binary composite polymeric materials, J. Polym. Sci., Polym. Phys. Ed. 23 (1985) 1309-24 presents a comparative summary of various models. A particularly useful model was developed by J. C. Maxwell, Treatise on Electricity and Magnetism, Oxford University Press, London in 1873 to predict the permittivity of a dielectric. The constitutive equations governing electrical potential and the flux through membranes are analogues, permitting the applicability of Maxwell's results to transport in mixed matrix membranes. See, e.g., R. H. B. Bouma, A. Checchetti, G. Chidichimo and E. Drioli, Permeation through a heterogeneous membrane: the effect of the dispersed phase, J. Membr. Sci. 128 (1997), pp. 141-149. The solution to calculate the effective permeability of mixed matrix membrane with a dilute dispersion of ellipsoids is disclosed in Bouma:

$${P}_{eff} = {P}_{c} [ \frac{n \cdot {P}_{d} + ( 1 - n ) {P}_{c} - ( 1 - n ) {φ}_{d} ( {P}_{c} - {P}_{d} )}{n \cdot {P}_{d} + ( 1 - n ) {P}_{c} + n {φ}_{d} ( {P}_{c} - {P}_{d} )} ] \qquad ( 1 )$$

where P_{eff} is the effective permeability of a gas penetrant in a mixed matrix membrane with a volume fraction (Φ_{d}) of dispersed phase (d) in a continuous matrix phase (c), P_{c} and P_{d} represent the gas penetrant permeabilities in the continuous (polymeric) and dispersed (molecular sieve) phases, respectively, and n is the shape factor of the dispersed (sieve) phase. The limit of n=0 corresponds to parallel transport through a mixed matrix membrane made of side-by-side layers of the two phases (laminate) and can be expressed as an arithmetic mean of the dispersed and continuous phase permeabilities:

P_{eff}=P_{c}(1−φ_{d})+φ_{d}P_{d} (2)

The limit of n=1 corresponds to transport through the two phases (or laminate) in series:

$${P}_{eff} = \frac{{P}_{c} {P}_{d}}{{P}_{d} ( 1 - {φ}_{d} ) + {φ}_{d} {P}_{c}} \qquad ( 3 )$$

The result for dilute suspension of spherical particles (n=⅓) is known as the Maxwell equation:

$${P}_{eff} = {P}_{c} [ \frac{{P}_{d} + 2 {P}_{c} - 2 {φ}_{d} ( {P}_{c} - {P}_{d} )}{{P}_{d} + 2 {P}_{c} + {φ}_{d} ( {P}_{c} - {P}_{d} )} ] \qquad ( 4 )$$

The Maxwell Model, as expressed in Equation (4), has been applied by many researchers to predict mixed matrix behavior. Petropoulos has demonstrated that the Maxwell Model may be further applicable at higher concentrations.

After calculating the effective permeabilities of the penetrants through the mixed matrix membrane, the predicted ideal selectivity of the mixed matrix membrane for a gas pair is simply the ratio of effective permeabilities of two competing gas penetrants. For example, the ideal selectivity for a mixture consisting of penetrants A and B is:

$${α}_{A / B}^{*} = \frac{{( {P}_{eff} )}_{A}}{{( {P}_{eff} )}_{B}} \qquad ( 5 )$$

### Example 1

### Properties of a Mixed Matrix Membrane for N₂/CH₄

In one embodiment, a mixed matrix composite (MMC) membrane is used to achieve the necessary selectivity for the nitrogen/methane separation. MMC materials consist of a polymer matrix impregnated uniformly with micron-sized zeolite crystals. The volume fraction of zeolite crystals in the MMC may vary, but an exemplary practical value is about 40%. The polymer matrix largely provides the membrane with the desired manufacturability and permeability, while the zeolite crystals provide a substantial boost to the selectivity far beyond what is achievable in pure-polymer membranes. A pure-zeolite membrane would have the maximum selectivity, but would not be practical due to the brittleness of the membrane. The properties are predicted by the Maxwell Equation, as discussed above and which is well-known to those skilled in the art.

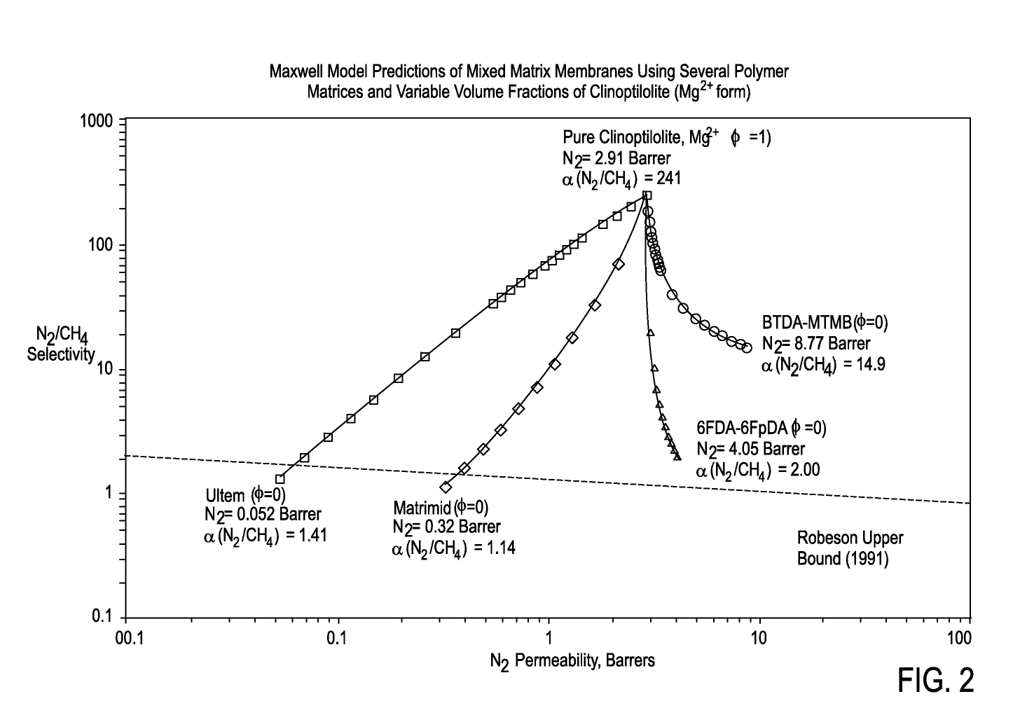

In an exemplary embodiment a clinoptilolite zeolite that is fully-exchanged with Mg²⁺ cations is utilized as the zeolite crystal in combination with an appropriate polymer such as a polyimide (e.g., Matrimid, 6FDA-6FpDA, BDTA-MTMB). It is well known to those skilled in adsorption that certain forms of clinoptilolites exhibit substantial kinetic selectivity for nitrogen over methane. The separation properties of this embodiment is described by the N₂/CH₄ selectivity vs. N₂ permeability plot in FIG. 2.

### Example 2

### Performance of a Mixed Marix Membrane for N₂/CH₄

The exemplary embodiment below illustrates how a mixed matrix membrane in hollow-fiber form, with a N₂/CH₄ selectivity of 20 could be capable of producing U.S. pipeline-quality gas (N₂<4 mol. %) from a feed of 15% N₂/85% CH₄ in a single stage.

Operating parameters include:

Flowrate: 50 MMSCFD (2.08×10⁶ SCFH)

Composition: 15 mol % N₂/85 mol %

Pressure: 1000 psia (6.9 MPa)

Temperature: 45° C.

The MMC embodiment for this example is a polyimide blend, BDTA-MTMB9 with 40 vol. % of Mg-clinoptilolite (N₂/CH₄ selectivity=20). The membranes will be configured in a hollow-fiber module. The membrane properties and operating parameters are

N₂ Permeability in MMC: 6.06 barrer

CH₄ Permeability in MMC: 0.30 barrer

Thickness of Active Layer: 0.1 micron

Fiber Outer Diameter: 300 micron

Fiber Inner Diameter: 150 micron

Fiber Active Length: 0.8 m

Permeate Pressure: 30 psia (210 kPa)

Simulations were carried out with a computer program. The number of fibers was varied, and the stage cut (ratio of permeate to feed flows), CH₄ recovery in the retentate, and permeate and retentate compositions were determined. The results are set forth below in Table 1:

TABLE 1

| | | | Permeate | Permeate | Retentate | Retentate | CH₄ |
|---|---|---|---|---|---|---|---|
| | | Stage | N₂ | CH₄ | N₂ | CH₄ | Recovery |
| # fibers | Area (m²) | cut | (mol fr) | (mol fr) | (mol fr) | (mol fr) | (%) |
| 5 × 10⁶ | 3.8 × 10³ | 0.104 | 0.6817 | 0.3183 | 0.0886 | 0.9114 | 96 |
| 1 × 10⁷ | 7.5 × 10⁵ | 0.177 | 0.6198 | 0.3814 | 0.0492 | 0.9508 | 92 |
| 1.5 × 10⁷ | 1.1 × 10⁴ | 0.233 | 0.5580 | 0.4420 | 0.0259 | 0.9741 | 88 |

From the calculations, it is clear that there is a tradeoff between the CH₄ product purity in the retentate and its recovery. These calculations were based on a single membrane stage, and improvements could be expected with a two-stage system. Unlike products obtainable with previous N₂/CH₄ membrane processes known in the art, the CH₄-rich product in the method of the present embodiments is in the retentate (high-pressure), rather than the permeate (low-pressure). The permeate gas, which still contains significant amounts of CH₄, may be used as low-BTU fuel gas or recompressed and fed to gas turbines for power generation.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. A mixed matrix membrane comprising: a continuous phase organic polymer with molecular sieves interspersed therein, the molecular sieves comprising one or more zeolites having an HEU structure type; wherein the membrane exhibits a mixed matrix effect and further wherein the membrane has a N₂/CH₄ selectivity of greater than about 5, at 35° C. and a pressure of 100 psia (690 kPa).

2. The mixed matrix membrane of claim 1, wherein the loading of the molecular sieves in the membrane is between about 10 to about 60% by volume.

3. The mixed matrix membrane of claim 1, wherein the loading of the molecular sieves in the membrane is between about 20 to about 50% by volume.

4. The mixed matrix membrane of claim 1, wherein the continuous phase polymer comprises a crosslinked or uncrosslinked polymer.

5. The mixed matrix membrane of claim 1, wherein the continuous phase polymer is selected from the group consisting of polyetherimides, polyimides, 6FDA/BPDA-DAM, 6FDA-6FpDA, and 6FDA-IPDA.

6. The mixed matrix membrane of claim 1, wherein the zeolite is clinoptilolite, huelandite or mixtures thereof.

7. The mixed matrix membrane of claim 1, wherein the zeolite contains at least one exchanged metal cation.

8. The mixed matrix membrane of claim 7, wherein the metal cation is a Group IIA metal.

9. The mixed matrix membrane of claim 7, wherein the metal cation is a magnesium cation.

10. The mixed matrix membrane of claim 7, wherein the zeolite is clinoptilolite and the metal cation is magnesium.

11. The mixed matrix membrane of claim 1, wherein the molecular sieves contain ultramicropores of an effective size and geometry such that when the mixed matrix membrane is prepared having about 30% by weight loading of sieves, the membrane exhibits a pure gas selectivity enhancement of 20% or more in permeability of N₂ relative to CH₄ when compared against a membrane made of the same continuous phase polymer but without the molecular sieves.

12. The mixed matrix membrane of claim 1, wherein the molecular sieves contain ultramicropores of an effective size and geometry such that when the mixed matrix membrane is prepared having about 40% by weight loading of sieves, the membrane exhibits a pure gas selectivity enhancement of 30% or more in permeability of N₂ relative to CH₄ when compared against a membrane made of the same continuous phase polymer but without the molecular sieves.

13. The mixed matrix membrane of claim 1, which possesses a definite configuration selected from the group consisting of a hollow fiber and a spiral wound module.

14. A method of making a mixed matrix membrane which comprises (a) providing a continuous phase organic polymer; (b) providing molecular sieves comprising one or more zeolites having an HEU structure type; (c) dispersing the molecular sieves into a solution containing the continuous phase organic polymer; and (d) allowing the continuous phase organic polymer to solidify about the molecular sieves to produce a mixed matrix membrane; whereby the mixed matrix membrane exhibits a mixed matrix effect and further wherein the membrane has a N₂/CH₄ selectivity, of greater than about 5, at 35° C. and a pressure of 100 psia.

15. The method of claim 14, wherein the loading of the molecular sieves in the membrane is between about 10 to about 60% by volume.

16. The method of claim 14, wherein the continuous phase polymer comprises a crosslinked or uncrosslinked polymers.

17. The method of claim 14, wherein the zeolite contains at least one exchanged metal cation.

18. The method of claim 17, wherein the zeolite is clinoptilolite and the metal cation is magnesium.

19. The method of claim 14, wherein the molecular sieves contain ultramicropores of an effective size and geometry such that when the mixed matrix membrane is prepared having about 30% by weight loading of molecular sieves, the membrane exhibits a pure gas selectivity enhancement of 20% or more in permeability of N₂ relative to CH₄ when compared against a membrane made of the same continuous phase polymer but without the molecular sieves.

20. The method of claim 14, wherein the molecular sieves contain ultramicropores of an effective size and geometry such that when the mixed matrix membrane is prepared having about 40% by weight loading of molecular sieves, the membrane exhibits a pure gas selectivity enhancement of 30% or more in permeability of N₂ relative to CH₄ when compared against a membrane made of the same continuous phase polymer but without the molecular sieves.

21. A method for separating gas components from a feedstream containing a mixture of gas components, the method comprising:
(a) providing a mixed matrix membrane comprising: a continuous phase organic polymer with molecular sieves interspersed therein, the molecular sieves comprising one or more zeolites having a HEU structure type; and
(b) directing a feedstream including nitrogen and methane gas components to the feed side of the membrane and withdrawing a retentate stream depleted in the nitrogen gas component from the feed side and withdrawing a permeate stream enriched in the nitrogen gas component from the permeate side of the membrane, wherein the membrane has a N₂/CH₄ selectivity of greater than about 5, at 35° C. and a pressure of 100 psia (690 kPa).

22. The method of claim 21, wherein the zeolite contains at least one metal cation.

23. The method of claim 21, wherein the molecular sieves contain ultramicropores of an effective size and geometry such that when the mixed matrix membrane is prepared having about 30% by weight loading of molecular sieves, the membrane exhibits a pure gas selectivity enhancement of 20% or more in permeability of N₂ relative to CH₄ when compared against a membrane made of the same continuous phase polymer but without the molecular sieves.

24. The method of claim 21, wherein the molecular sieves contain ultramicropores of an effective size and geometry such that when the mixed matrix membrane is prepared having about 40% by weight loading of molecular sieves, the membrane exhibits a pure gas selectivity enhancement of 30% or more in permeability of N₂ relative to CH₄ when compared against a membrane made of the same continuous phase polymer but without the molecular sieves.
